(19) United States
(12) Patent Application Publication
(10) Pub. No.: US 2014/0000422 A1
(43) Pub. Date: Jan. 2, 2014

(54) Tool Handle

(71) Applicant: Chin-Tan Huang, Taichung City (TW)

(72) Inventor: Chin-Tan Huang, Taichung City (TW)

(21) Appl. No.: 13/785,079

(22) Filed: Mar. 5, 2013

(30) Foreign Application Priority Data
Jun. 29, 2012 (TW) 101212662

(51) Int. Cl. B25G 1/00

(52) U.S. Cl. CPC B25G 1/00
USPC 81/489

(57) ABSTRACT

A tool handle includes a first handle unit including a first handle body and an engaging block that protrudes obliquely from the first handle body, a joint unit mounted rotatably around the engaging block and formed with an oblong groove, a second handle unit connected co-rotatably with the joint unit, and a latch member mounted movably to the first handle unit and able to switch between a lock state, where the latch member engages the oblong groove and the first and second handle units are non-rotatable relative to each other, and an unlock state, where the latch member is disengaged from the oblong-groove and the second handle unit is rotatable about the engaging block to adjust an orientation of the second handle unit relative to the first handle unit.

### CROSS-REFERENCE TO RELATED APPLICATION

This application claims priority of Taiwanese Application No. 101212662, filed on Jun. 29, 2012.

### BACKGROUND OF THE INVENTION

1. Field of the Invention

The invention relates to a hand tool, more particularly to a tool handle.

2. Description of the Related Art

Referring to FIGS. 1 and 2, Taiwanese Patent Publication No. 201210761 discloses a conventional tool handle 1 including a first handle unit 11, a joint unit 12, a second handle unit 13, and a lock unit 14.

The first handle unit 11 has a first handle body 113 that has an inclined end surface 111, and an engaging protrusion 112 that protrudes from the end surface 111. The joint unit 12 includes an annular surrounding wall 122 that is formed by two joint pieces 121 and that is mounted rotatably around the engaging protrusion 112. The annular surrounding wall 122 is formed with two diametrically spaced-apart locking grooves 123. The second handle unit 13 is connected co-rotatably to the joint unit 12. The lock unit 14 includes a lock member 141 that is mounted movably to the first handle unit 11, and that is operable to engage and disengage one of the locking grooves 123.

When the lock member 141 engages one of the locking grooves 123, the first arid second handle units 11, 13 are non-rotatable relative to each other. When the lock member 141 is operated to be disengaged from the one of the looking grooves 123, the joint unit 12 and the second handle unit 13 are rotatable about the protrusion 112 of the first handle unit 11 to register the other one of the locking grooves 123 with the lock member 141. Then, the lock member 141 is further operable to engage the registered lock groove 123 to restrain, the rotation of the joint unit 12 and the second handle unit 13 relative to the first handle unit 11. As a result, an orientation of the second handle unit 13 relative to the first handle unit 11 is adjusted.

In use, when the conventional tool handle 1 is rotated, the lock member 141 and the one of the locking grooves 123 engaged with the lock member 141 are subjected to a torque transferred from the first handle unit 11 to the second handle unit 13. However, since the structure of the surrounding wall 122 that defines the locking grooves 123 is weaker than the second handle unit 13, and since the dimensions and locations of the locking grooves 123 and the lock member 141 are limited by the configuration and the dimension of the surrounding wall 122, the surrounding wall 122 may easily be split and the look member 141 may even fracture once the torque is too large.

### SUMMARY OF THE INVENTION

Therefore, the object of the present invention is to provide a tool handle that can bear a relatively large torque.

Accordingly, a tool handle of the present invention is adapted for connection with a tool head and comprises:

a first handle unit including
a first handle body that has a first axis and a handle end surface oblique to the first axis, and
an engaging block that protrudes from the handle end surface;

a joint unit having
a joint base surface that confronts the handle end surface,
a joint surrounding wail that extends around and from the joint base surface towards the handle end surf ace arid that is mounted rotatably around the engaging block, and
an oblong groove that is formed in the joint base surface;

a second handle unit including a second handle body that defines a retaining space therein for retaining the joint unit, and that is co-rotatable with the joint unit;

an installing unit having an installing space that is formed in one of the first and second handle units and that is adapted for receiving the tool head; and

a lock unit including a latch-member that is mounted movably to the first handle unit, that has a latching portion elongated in a direction substantially parallel to the handle end surface, and that is movable along the first axis to switch between a lock state where the latching portion engages the oblong groove and an unlock state where the latching portion is disengaged from the oblong groove;

wherein, when the latch member is in the lock state, the first and second handle units are non-rotatable relative to each other, and when the latch member is in the unlock state, the second handle unit is rotatable about the engaging block to thereby adjust an orientation of the second handle unit relative to the first handle unit.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional tool handle;

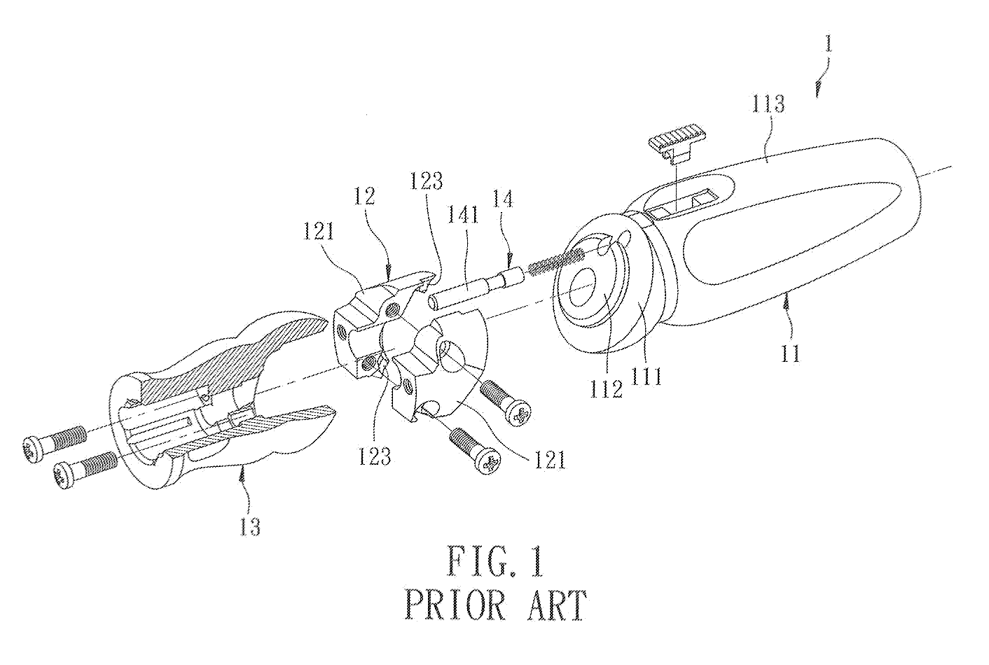

FIG. 2 is a perspective view of a joint unit of the conventional tool handle;

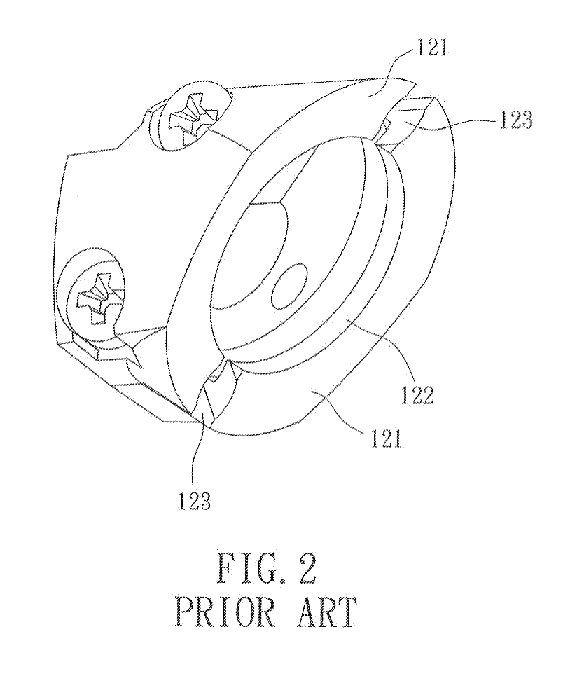

FIG. 3 is an exploded perspective view of a preferred embodiment of a tool handle according to the invention;

FIG. 4 is another exploded perspective view of the preferred embodiment;

FIG. 5 is a side view of the preferred embodiment and a tool head for connection with the preferred embodiment;

FIG. 6 is an exploded perspective view of a joint unit of the preferred embodiment;

FIG. 7 is a sectional view of the preferred embodiment, where a latch member is at a lock state;

FIG. 8 is another sectional view of the preferred embodiment, where the latch member is at an unlock state; and

FIG. 9 is still another sectional view of the preferred embodiment, where an orientation of a first handle unit relative to a second handle unit is adjusted.

### DETAILED DESCRIPTION OF THE PREFERRED EMBODIMENT

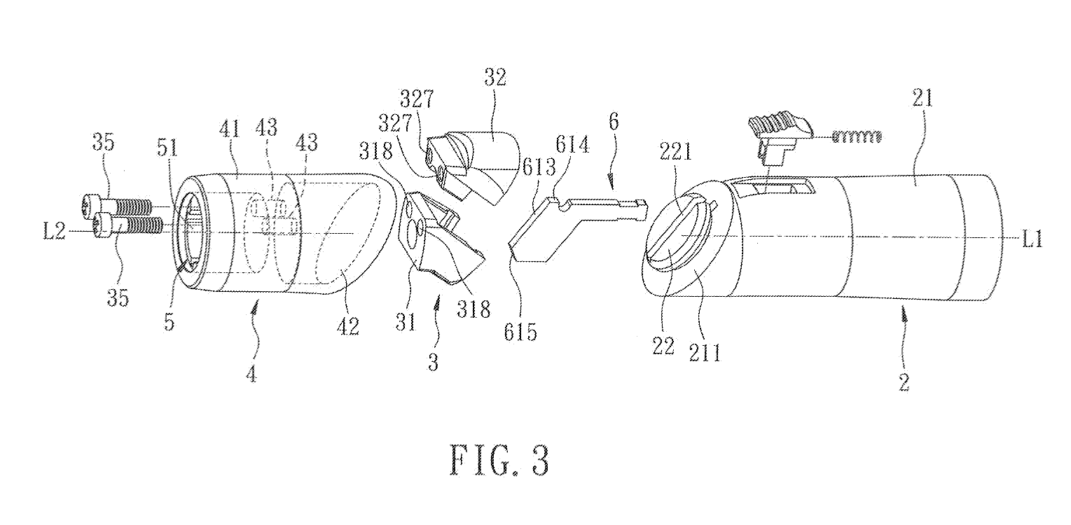

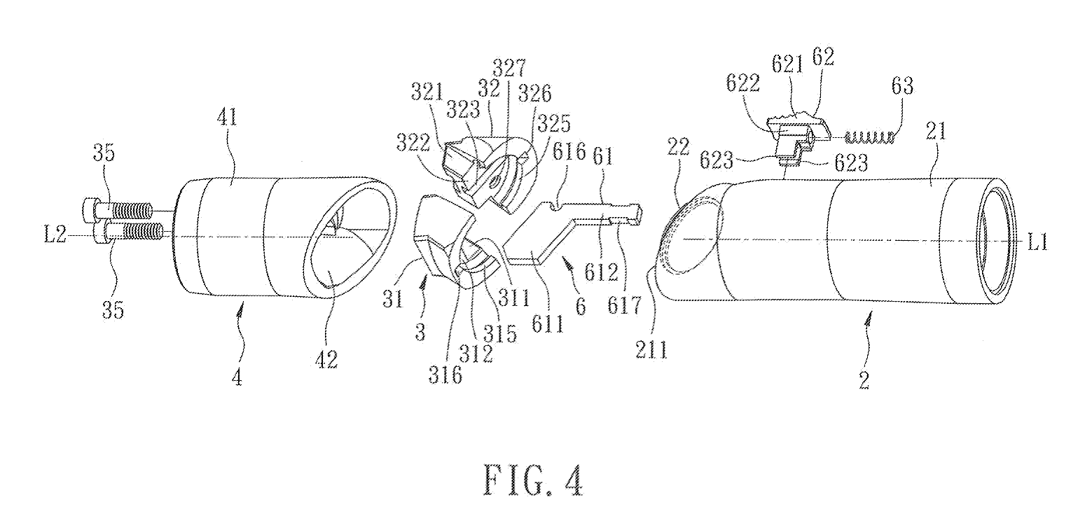

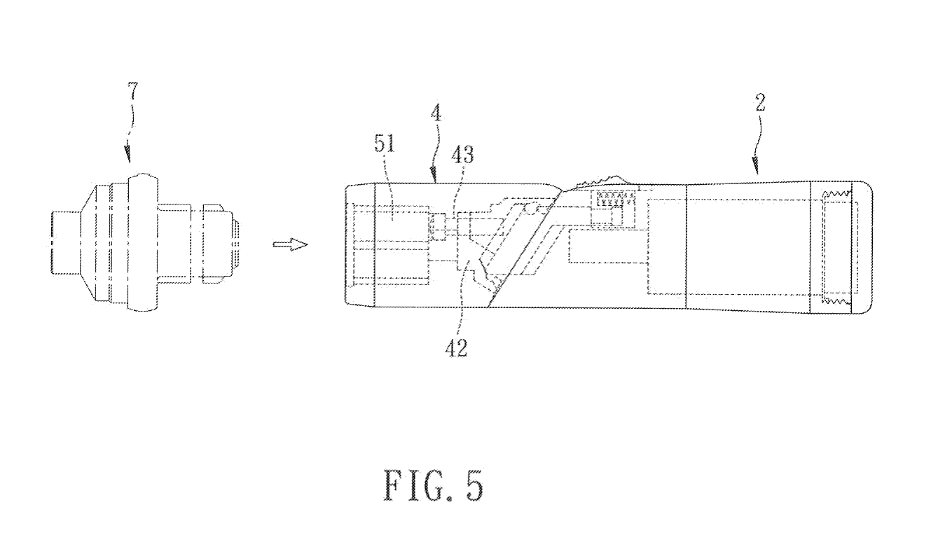

As shown in FIGS. 3 to 6, the preferred embodiment of a tool handle according to the present invention is adapted for connection with a tool head 7. The tool handle comprises a first handle unit 2, a joint unit 3, a second handle unit 4, an installing unit 5, and a lock unit 6.

The first handle unit 2 includes a first handle body 21 that has a first axis (L1) and a handle end surface 211 oblique to the first axis (L1), and an engaging block. 22 that protrudes from the handle end surface 211 and that is formed with a through slot 221.

The joint unit 3 includes first and second pieces 31, 32 that are interconnected and that are mounted rotatably around, the engaging block 22.

Each of the first and second pieces 31, 32 has a bulk portion 311, 321, a bulk surface 312, 322 formed on the bulk portion 311, 321 and confronting the handle end surface 211, a bulk groove 313, 323 formed in the bulk surface 312, 322, a bulk wall portion 314, 324 extending around the bulk surface 312, 322 and toward the handle end. surface 211, an internal flange portion 315, 325, extending inwardly from an end of the bulk wail portion 314, 324 and spaced apart from the bulk surface 312, 322, and a flange notch 316, 326 formed in the internal flange portion 315, 325.

In this embodiment, the bulk portions 311, 321 of the first and second pieces 31, 32 are interconnected complementarily. The bulk surfaces 312, 322 of the first and second pieces 31, 32 are coplanar and cooperatively define a joint base surface 36 confronting the handle end surface 211. The bulk grooves 313, 323 of the first and second pieces 31, 32 cooperatively define an oblong groove 33 in the joint base surface 36. The bulk wall portions 314, 324 of the first and second pieces 31, 32 cooperatively define a joint surrounding wall 37 mounted rotatably around the engaging block 22. The joint base surface 36 and the joint surrounding wall 37 cooperatively define an engaging space 34 engaged with the engaging block 22. The internal flange portions 315, 325 of the first and second pieces 31, 32 cooperatively define an internal annular flange 38. The flange notches 316, 326 are angularly spaced-apart in the internal annular flange 38.

The bulk portion 311 of the first piece 31 has a recessed part 317 overlapping with the bulk portion 321 of the second piece 32, and a through hole unit extending along a second axis (L2) and formed in the recessed part 317. The through hole unit has a pair of spaced-apart through holes 318. The bulk portion 321 of the second piece 32 of the joint unit 3 has a protrusion 328 engaging complementarily the recessed part 317, and a pair of threaded holes 327 registered respectively with the through holes 318.

The second handle unit 4 includes a second handle body 41 that surrounds the second axis (L2), that defines a retaining space 42 therein for retaining the joint unit 3, that is connected co-rotatably to the joint unit 3, and that is formed with a pair of connecting holes 43 registered respectively with the through holes 318 of the first piece 31 of the joint unit 3.

The joint unit 3 further includes a pair of screws 35. Each of the screws 35 extends through a respective one of the connecting holes 43 and a registered one of the through holes 318, and engages threadedly a registered one of the threaded holes 327 for securing the first and second pieces 31, 32 to the second handle body 41.

The installing unit 5 has an installing space 51 that is formed in one of the first and second handle units 2, 4 for receiving the tool head 7.

In this embodiment, the installing space 51 is formed in the second handle unit 4. The connecting holes 43 of the second handle unit 4 communicate spatially the installing space 51 and the engaging space 34 for extension of the screws 35.

The lock unit 6 includes a latch member 61 that is mounted movably to the first handle unit 2, and that is movable along the first axis (L1), a push member 62 that is connected co-movably to the latch member 61, and a biasing member 63 that is disposed, between the push member 62 and the first handle body 21 for biasing the latch member 61 and the push member 62 toward the joint unit 3.

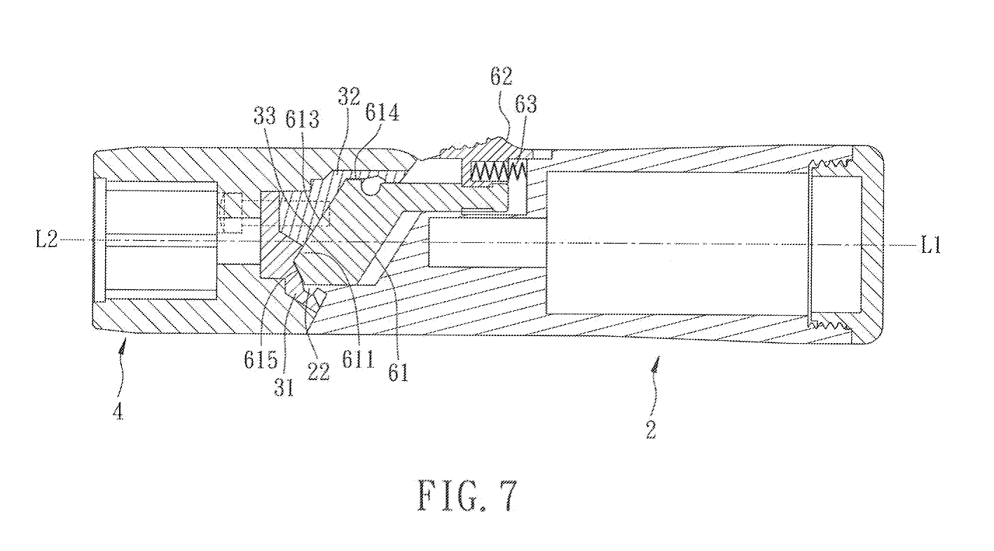

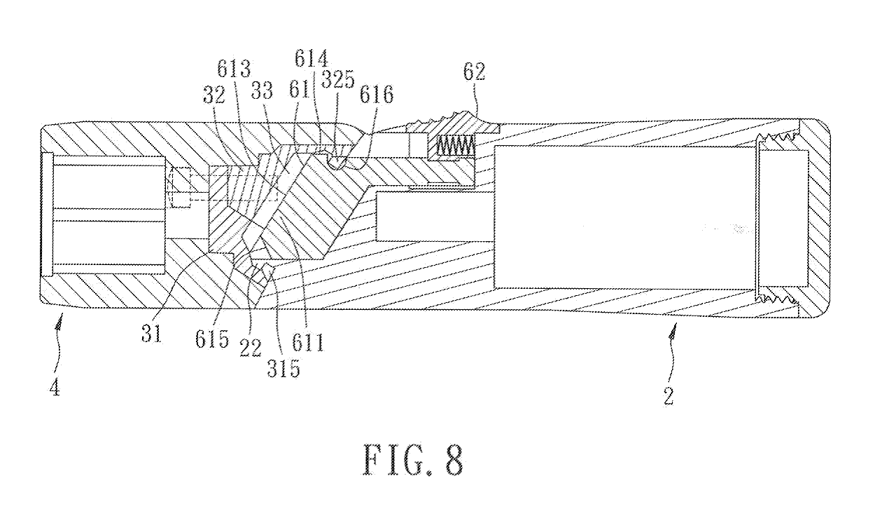

The latch member 61 has a latching portion 611 elongated in a direction substantially parallel to the handle end surface 211 and extending through the through slot 221 of the engaging block 22, and an arm portion 612 connected to the latching portion 611 and extending parallel to the first axis (L1) and extending non-rotatably into the first handle body 21. As such, the latch member 61 is non-rotatable relative to the first handle unit 2. The push member 62 has a knob portion 621 mounted to and exposed from the first handle body 21 for manual operation, and a retaining portion 622 extending into the first handle body 21 from the knob portion 621 and connected to the arm portion 612 of the latch member 61. The latch member 61 is operable via the push member 62 to switch between a lock state (see FIG. 7) where the latching portion 611 engages the oblong groove 33, and an unlock state (see FIG. 8) where the latching portion 611 is disengaged from the oblong groove 33.

The latching portion 611 of the latch member 61 has a thickness smaller than a width of each of the flange notches 316, 326. The latching portion 611 further has an oblong first surface 613 confronting the oblong groove 33, and second and third surfaces 614, 615 connected respectively to two opposite ends of the first surface 613. The second surface 614 is connected to the arm portion 62, and is formed with a latch notch 616. The internal annular flange 38 is operable to extend movably through the latch notch 618 when the latch member 61 is in the unlock state.

In this embodiment, the arm portion 612 of the latch member 61 is formed with a notch 617. The retaining portion 622 of the push member 62 has a pair of catch levers 623 retaining the arm portion 612 and engaging the notch 617 in a snap manner.

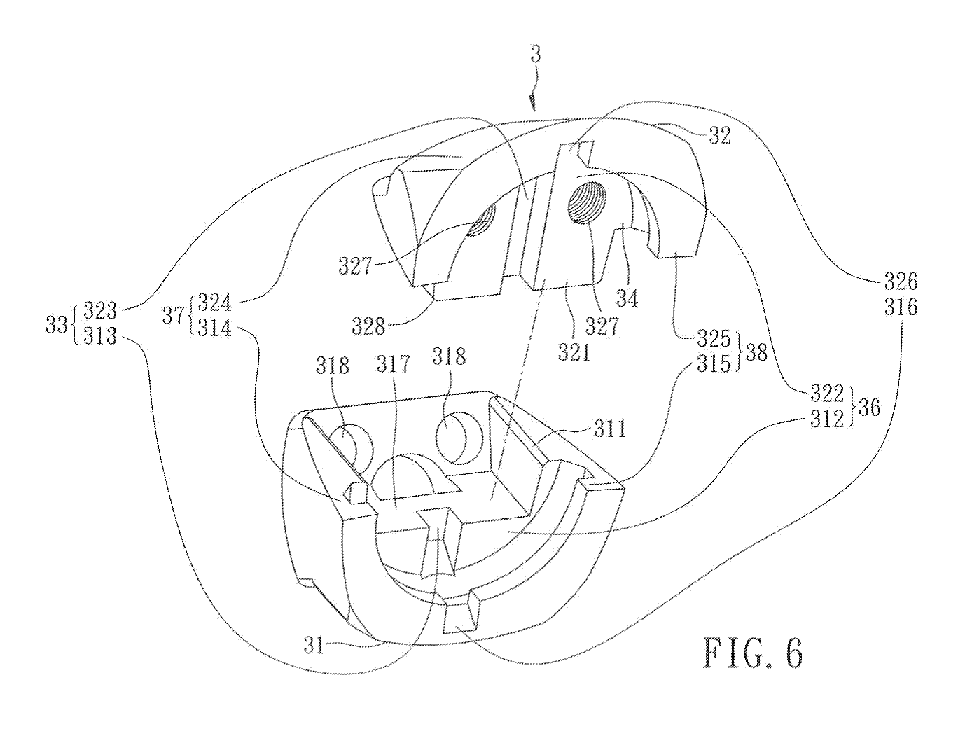

Referring to FIGS. 6 and 7, before adjustment of the orientation of the first handle unit 2 relative to the second handle unit 4, the tool handle of the preferred embodiment is in a first position, where the first axis (L1) and the second axis (L2) are collinearly disposed, where the biasing member 63 pushes the latch member 61 to be in the lock state, and where the latching portion 611 extends into the engaging space 34 with a portion of the latching portion 611 adjacent to the second surface 614 extending through the flange notch 326 and with the first, second and third surfaces 613, 614, 615 of the latching portion 611 abutting against an inner surface of the oblong groove 33. The engagement between the latching portion 611 and the oblong groove 33 restrains the rotation of the joint unit 3, so that the first and second handle units 2, 4 are non-rotatable relative to each other.

Referring to FIGS. 6 and 8, the push member 62 is then operable to move the latch member 61 along the first axis (L1) and disengage the latching portion 611 from the oblong groove 33 against the resilient force of the biasing member 63 and to register the latch notch 616 with the one of the flange notches 316, 326 of the internal annular flange 38. Thus, the joint unit 3 and the second handle unit 4 are allowed to rotate relative to the first handle unit 2 with the internal annular flange 38 extending rotatably through the latch notch 616.

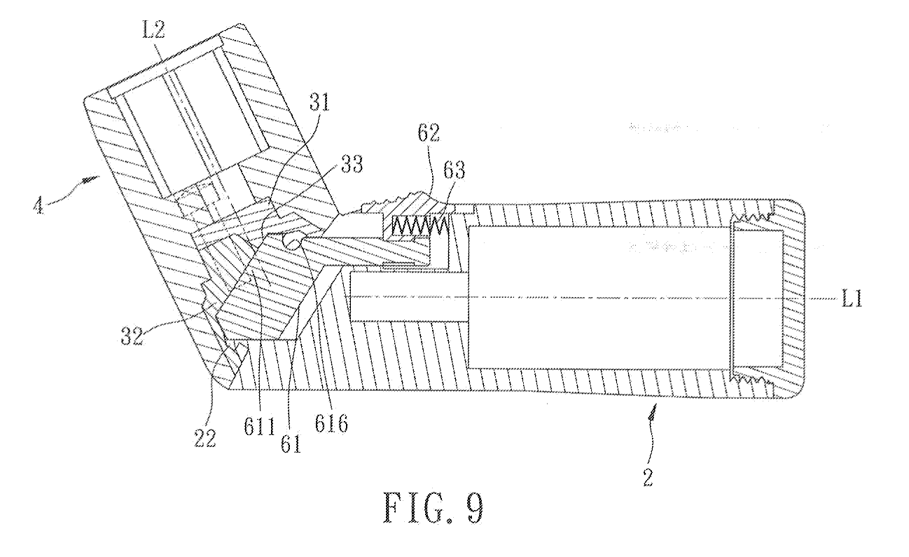

Referring further to FIGS. 6 and 9, when the joint unit 3 and the second handle unit 4 are rotated to register the other flange notch 316 with the latch notch 616, the latch member 61 is permitted to restore to the lock state by the biasing member 63. At this time, the tool handle is switched to a second position where an orientation of the first handle unit 2 relative to the second handle unit 4 is adjusted, where the first axis (L1) and the second axis (L2) are non-collinearly disposed, and where the first and second handle units 2, 4 are once again non-rotatable relative to each other.

Since the oblong groove 33 is formed in the bulk portions 311, 321 of the first and second pieces 31, 32 instead of the annular joint surrounding wall 37, the dimension of the oblong groove 33 is not limited by the annular joint surrounding wall 37. In this embodiment, both of the oblong groove 33 and the latching portion 611 of the latch member 61 are elongated and the engagement between the same forms a relative strong structure on which a torque transferred from the first handle unit 2 to the second handle unit 4 is applied. Consequently, the tool handle of this invention is capable of bearing a relatively large torque.

While the present invention has been described in connection with what is considered the most practical and preferred embodiment, it is understood that this invention is not limited to the disclosed embodiment but is intended to cover various arrangements included within one spirit and scope of the broadest interpretation so as to encompass all such modifications and equivalent arrangements.

What is claimed is:

1. A tool handle adapted for connection with a tool head, comprising:
a first handle unit including
a first handle body that has a first axis and a handle end surface oblique to the first axis, and
an engaging block that protrudes from said handle end surface;
a joint unit having
a joint base surface that confronts said handle end surface,
a joint surrounding wall that extends around and from said joint base surface towards said handle end surface and that is mounted rotatably around said engaging block, and
an oblong groove that is formed in said joint base surface;
a second handle unit including a second handle body that defines a retaining space therein for retaining said joint unit, and that is co-rotatable with said joint unit;
an installing unit having an installing space that is formed in one of said first and second handle units and that is adapted for receiving the tool head; and
a lock unit including a latch member that is mounted movably to said first handle unit, that has a latching portion elongated in a direction substantially parallel to said handle end surface, and that is movable along the first axis to switch between a lock state where said latching portion engages said oblong groove and an unlock state where said latching portion is disengaged from said oblong groove;
wherein, when said latch member is in the look state, said first and second handle units are non-rotatable relative to each other, and when said latch member is in the unlock state, said second handle unit is rotatable about said engaging block to thereby adjust an orientation of said second handle unit relative to said first handle unit.

2. The tool handle as claimed in claim 1, wherein said lock unit further includes:
a push member connected co-movably to said latch member; and
a biasing member disposed between said push member and said first handle body for biasing said latch member and said push member toward said joint unit so that said latching portion engages said oblong groove.

3. The tool handle as claimed in claim 2, wherein said latch member further has an arm portion that is connected to said latching portion and that extends axially into said first handle body, said push member having a knob portion mounted to and exposed from said first handle body for manual operation, and a retaining portion extending into said first handle body from said knob portion and connected co-movably to said arm portion.

4. The tool handle as claimed in claim 3, wherein said arm portion of said latch member is formed with a notch, and said retaining portion of said push member has a pair of catch levers retaining said arm portion and engaging said notch in a snap manner.

5. The tool handle as claimed in claim 1, wherein said, joint unit includes first and second pieces, each of said first and second pieces having a bulk portion, a bulk surface that is formed on said bulk portion and that confronts said handle end surface, a bulk groove that is formed in said bulk surface, and a bulk wall portion that extends around said bulk surface and toward said handle end surface, said bulk port ions of said first and second pieces being interconnected complementarily, said bulk surfaces of said first and second pieces being coplanar and cooperatively defining said joint base surface, said bulk grooves of said first and second pieces cooperatively defining said oblong groove, said bulk wall portions of said first and second pieces cooperatively defining said joint surrounding wall, said joint base surface and said joint surrounding wall cooperatively defining an engaging space that is engaged with said engaging block.

6. The tool handle as claimed in claim 5, wherein said bulk portion of said first piece has a recessed part overlapping with said bulk portion of said second piece, and at least one through hole extending along a second axis and formed in said recessed part, said bulk portion of said second piece of said joint unit having a protrusion that engages complementarily said recessed part, and at least one threaded hole that is registered with said through hole, said joint unit further including at least one screw that extends through said through hole, that engages threadedly said threaded hole, and that secures said first and second pieces to said second handle body.

7. The tool handle as claimed in claim 6, wherein said installing space is formed in said second handle unit, said second handle unit further having a connecting hole that communicates spatially said installing space and said engaging space for extension of said screw.

8. The tool handle as claimed in claim 1, wherein said joint unit further has an internal annular flange extending inwardly from an end of said joint surrounding wall, spaced apart from said joint base surface, and formed with a pair of angularly spaced-apart flange notches for extension of said latching portion of said latch member, said latching portion having a thickness smaller than a width of said flange notches and being formed with a latch notch, said latching portion extending into said engaging space of said joint unit through one of said flange notches, said internal annular flange extending movably into said latch notch when said latch member is in the unlock state,

9. The tool handle as claimed in claim 8, wherein said latching portion of said latch member further has an oblong first surface confronting said oblong groove, and second and third surfaces connected respectively to two opposite ends of said first surface, said second surface being connected to said arm portion, said latch notch being formed in said second surface.

10. The tool handle as claimed in claim 1, wherein said engaging block has a through slot for extension of said latch member.
